(19) United States
(12) Patent Application Publication
(10) Pub. No.: US 2024/0140876 A1
(43) Pub. Date: May 2, 2024

(54) POLYMER-DERIVED CERAMIC DIFFUSION PROCESS FOR FERROUS METAL SURFACES

(71) Applicant: Calvary Industries Inc., Fairfield, OH (US)

(72) Inventors: Christopher Berger, West Chester, OH (US); Jonathan Kerry Winters, Troy, OH (US)

(73) Assignee: Calvary Industries Inc., Fairfield, OH (US)

(21) Appl. No.: 18/297,425

(22) Filed: Apr. 7, 2023

Related U.S. Application Data
(60) Provisional application No. 63/381,049, filed on Oct. 26, 2022.

(51) Int. Cl. C04B 35/589; B21D 22/02; C04B 35/593; C04B 41/00; C04B 41/45

(52) U.S. Cl. CPC C04B 35/589; B21D 22/022; C04B 35/593; C04B 41/0072; C04B 41/4552; C04B 2235/483; C04B 2235/66

(57) ABSTRACT

A polymer-derived composition and method for providing a ceramic-based precursor coating on a metal surface are disclosed. The composition comprises one or more preceramic polymers admixed with one or more metal particulates. The composition is integrally disposed on and within the metal surface of a metal part through pressure-assisted pyrolysis of a metal particulate-filled preceramic polymer under appropriate conditions, thereby providing a corrosion-resistant and oxidation-resistant metal surface. The precursor coating composition is applied and dried onto the metal surface. The coated steel material is then hot stamped at a pre-defined temperature under a time and pressure conditions sufficient to pyrolyze precursor coating composition to form a protective coating on the surface of the steel. The coated steel material is then cooled. Further, the hot stamping is performed in a period of no more than 1 minute and at a temperature controlled at 400-800° C.

### CROSS-REFERENCE TO RELATED APPLICATIONS

This application claims the benefit of priority under 35 U.S.C. § 119(e) to U.S. Patent Application Provisional Application Ser. No. 63/381,049, entitled “POLYMER-DERIVED CERAMIC DIFFUSION PROCESS FOR FERROUS METAL SURFACES,” filed Oct. 26, 2022, the contents of which are hereby incorporated by reference in their entirety for any purpose.

### FIELD OF THE INVENTION

The present invention generally relates to surface treatment of metallic surfaces. More specifically, the present invention relates to a composition and method for forming a corrosion-resistant and oxidation-resistant surface on metals.

### BACKGROUND OF THE INVENTION

Hot stamping is a thermal forming process for sheet metal in which sheet metals are heated up to an austenite range, hot formed, and then die-quenched to form martensite structures. Hot stamping is also known as press hardening or hot press forming where forming and metallurgical heat-treating take place during the stamping process. Press hardening was originally developed in the 1970s to manufacture hardened steel agricultural tools. However, it has since had a major commercial impact on the fabrication of lightweight and high-strength white bodies in the automotive industry. Reduced fuel consumption and vehicle safety have driven the universal use of ultra-high strength steel components made possible by the advent of the hot stamping process.

Early development and progression of hot stamping were focused on low-carbon manganese boron alloyed steel 22MnB5 due to incumbent use and availability. By heating 22MnB5 sheet above 900° C. the microstructure of the metal is converted from ferritic steel to austenitic steel, then with rapid cooling in the stamping die, the steel phase is transformed into martensite, with a strength of up to 1500 MPa [220 KSI]. Higher carbon steel grades with specialized coatings and advanced chemical compositions have since been developed with strength up to 2000 MPa [290 KSI] and many significant process and material property advantages.

A typical hot stamping process for steel thus involves heating a steel sheet that is typically about 0.25 mm about 15 mm thick (although thicknesses down to 0.025 mm can also be hot stamped) to a temperature of about 900° C. to about 1,000° C. for 3-5 minutes to effect full austenitization of the metal structure, and then feeding the red hot sheet into a hydraulic press where it is shaped through pressing in a die at a temperature of about 500° C. to about 850° C. under an induced pressure of about 15 MPa to 600 MPa while rapidly cooling to achieve a fully martensitic microstructure.

Not all metals will exhibit the high strength transformation found in boron steels when hot stamped. The addition of boron to carbon steels promotes the phase transformation to martensite when rapidly cooled. Steel sheets that are not alloyed for phase transformation cannot be hardened to ultra-high strength, however, hardness tailoring via zone cooling and heating can be used to control microstructure and therefore material properties. Most nonferrous alloys will exhibit limited improvements in hardness but hot press forming can improve formability of complex shapes, eliminate spring back, and reduce defects in many applications.

Corrosion, decarbonization and scaling of sheet materials at high furnace temperatures is an issue for hot stamping. Uncoated steels require inert gas atmospheres to minimize scaling. Corrosion resistant coatings, such as aluminum-silicon, are often applied to sheet steels to eliminate the need for scale removal. The addition of specific alloying elements can also reduce corrosion and in some cases reduce the cooling required to maintain hardness and permit multi step forming operations.

Despite the inherent advantages of forming parts by the hot stamping method, corrosion, decarbonization and scaling of sheet materials at high furnace temperatures is an issue for hot stamping. Uncoated steels require inert gas atmospheres to minimize scaling. Therefore, there exists a need to provide oxidation-resistance to steel parts that have been fabricated by way of a “hot stamping” process.

A prior art U.S. RE44153E, assigned to ArcelorMittal Atlantique et Lorraine (FR)], entitled “Coated hot- and cold-rolled steel sheet comprising a very high resistance after thermal treatment” discloses a process and composition to prevent oxidation. The sheeted, 22MnB5 steel [0.221C, 1.29Mn, 0.28Si, 0.13Ni, 0.193Cr, 0.01Cu, 0.001S, 0.018P, 0.032A1, 0.005V, 0.039Ti, 0.0038B] is dip-coated with aluminum metal or an aluminum metal alloy comprising silicon. The coated steel can then be hot stamped to shape vehicular parts with minimal problems arising from oxidation. Due to the complexity of the process, the resulting part is very expensive.

Thus, there is a need for a novel method for providing a corrosion-resistant and oxidation-resistant surface to metals. Also, there is a need for a composition and method for creating a corrosion-resistant and oxidation-resistant surface for ferrous metals that are shaped through a hot stamping process.

### SUMMARY OF THE INVENTION

The present invention generally discloses a composition and method for forming a corrosion-resistant and oxidation-resistant surface on metals. Further, the present invention discloses a corrosion-resistant and oxidation-resistant composition that is integrally disposed on and within the surface of a metal formed by a method comprising the pyrolysis of a metal particulate-filled preceramic polymer. In another embodiment, the present invention provides compositions and methods for creating a corrosion-resistant and oxidation-resistant surface for ferrous metals that are shaped through a hot stamping process. The process is based on a ceramic precursor coating composition comprising metal particulate. In one or more embodiments, the precursor coating composition comprises a silicon-containing preceramic polymer.

According to the present invention, a composition and a method for the production of the composition are disclosed. In one embodiment, the composition is a polymer-derived composition for providing a ceramic-based precursor coating on a metal surface. In one embodiment, the composition comprises one or more preceramic polymers admixed with one or more metal particulates. In one embodiment, the composition is integrally disposed on and within the metal surface of a metal part through pressure-assisted pyrolysis of a metal particulate-filled preceramic polymer under appropriate conditions, thereby providing a corrosion-resistant and oxidation-resistant metal surface. In one embodiment, the metal part is a ferrous metal part that is selected from the group consisting of iron, steel, and stainless steel. In one embodiment, the metal part is in the form of a continuous metal sheet.

In some embodiments, the preceramic polymers may be selected from a group comprising, but not limited to, borazine-modified hydridopolysilazanes, boropolycarbosiloxane, decaborane-based polymers, polyaluminocarbosilane, polyborazylene, polycarbosilanes, polycarbosilazanes, polysilacarbosilanes, polysilacarbosilazanes, polysilanes, polysilasilazane, polysilazanes, polysiloxazanes, polysilylcarbodiimides, polyvinylborazine, silicone resins, metal-modified preceramic polymers, and mixtures thereof. The polymeric preceramic precursor may be comprised of a polymer where the backbone is primarily comprised of C—C bonds, for example, polysilylcarbodiimides.

In one or more embodiments, the preceramic polymer is selected from the group consisting of borazine-modified hydridopolysilazanes, polycarbosilanes, polycarbosilazanes, polysilacarbosilanes, polysilacarbosilazanes, polysilanes, polysilasilazane, polysiloxazanes, polysilylcarbodiimides, silicone resins, and mixtures thereof. In another embodiment, the preceramic polymer further comprises one or more polymers selected from the group consisting of polyvinylborazine, polyborazylene, and decaborane-based polymers.

In one or more embodiments, the preceramic polymer comprises one or more of the following: polysiloxanes, polysilsesquioxanes, polycarbosiloxanes, polyborosilanes, polyborosiloxanes, polysilazanes, poly-silsesquiazanes, polyborosilazanes, polycarbosilanes, polysilylcarbodiimides, and polysilsesquicarbodiimides.

In another embodiment, the preceramic polymer comprises one or more of a polyacetal, a polyolefin, a poly(alkylene oxide), a poly(meth)acrylate, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polysilazane, a polyethylene terephthalate, a polybutylene terephthalate, a polyurethane, an ethylene propylene diene rubber, a polytetrafluoroethylene, a fluorinated ethylene propylene, a perfluoroalkoxyethylene, a polychlorotrifluoroethylene, a polyvinylidene fluoride, or a combination thereof.

In another embodiment, the preceramic polymer is a silicon-containing preceramic polymer selected from the group consisting of polysilazanes, polycarbosilanes, polysiloxanes, polysilsesquioxanes, polysilanes, and mixtures thereof. In another embodiment, the silicon-containing preceramic polymer is a polysilazane. In another embodiment, the polysilazane is selected from the group consisting of hydridosilazanes, vinyl modified polysilazanes, silacyclobutasilazanes, vinyl modified poly(disilyl)silazanes, borosilazanes, boron modified hyrdopolysilazanes, vinyl-modified hydridopolysilazanes.

In one embodiment, the metal particulate is selected from the group consisting of aluminum and silicon. In some embodiments, the metal particulate is aluminum. In one embodiment, the metal particulate comprises a ratio of silicon (Si) to aluminum (Al) atoms between 0.25:1.75 and 1.75:0.25. In one embodiment, the metal particulate comprises a ratio of silicon (Si) to aluminum (Al) atoms between 0.50:1.50 and 1.50:0.50.

In one embodiment, the dry film ratio of silicon to aluminum would represent ratios of polysilazane to aluminum meta weight ratio of 0.34 to 16.7. In the narrower ranges of 0.50 to 1.50 and 1.50 to 0.50, the ratio comes to 0.79 to 7.13.

In one embodiment, the dry film ratio of silicon to aluminum is 34 wt. % to 94 wt. % polysilazane, 66 wt. % to 6 wt. % Aluminum metal [0.34 to 16.7]. In one embodiment, the dry film ratio of silicon to aluminum is 79 wt. % to 88 wt. % polysilazane, 31 wt. % to 12 wt. % Aluminum metal [0.79 to 7.13]. In one embodiment, the dry film ratio of silicon to aluminum is a 1:1 ratio of silicon to aluminum metal would be 64.2 g polysilazane to 27.0 g aluminum metal, or 2.4. In one embodiment, the dry film ratio of silicon to aluminum is 71 wt. % polysilazane to 31 wt. % aluminum metal.

In another embodiment, the dry film compositions of precursor coating that are spray coated or coil coated onto the steel or stainless steel surfaces comprise about 34 wt. % to 94 wt. % polysilazane and 66 wt. % to 6 wt. % aluminum metal based on the total amount of polysilazane and aluminum metal contained in the coating.

In another embodiment, the dry film compositions that are spray coated or coil coated onto the steel or stainless steel surface comprise 79 wt. % to 88 wt. % polysilazane and 31 wt. % to 12 wt. % aluminum metal based on the total amount of polysilazane and aluminum metal contained in the coating. In another embodiment, the dry film compositions that are spray coated or coil coated onto the steel or stainless steel surface comprise 71 wt. % polysilazane and 31 wt. % aluminum metal based on the total amount of polysilazane and aluminum metal contained in the coating.

In one embodiment, the composition comprises a SiAlON-containing ceramic material. In one embodiment, the metal part is a ferrous metal part that is selected from the group consisting of iron, steel, and stainless steel. In one embodiment, the metal part is in the form of a continuous metal sheet.

In one embodiment, the composition comprises polysilazane and aluminum metal particulate. The polysilazane and aluminum metal particulate are used in sequential coil coating and hot stamping process. The polysilazane and aluminum metal particulate react upon exposure to heat and pressure while preparing ceramic compositions. In one embodiment, the elemental constituents comprising the coating composition react upon exposure to heat and pressure during the process to produce ceramic compositions. In one embodiment, the ceramic compositions react with the metal surface through a diffusion process to provide a composite coating. The composite coating includes aluminum oxides, ceramic inclusions, and ferrous alloys on the metal surface, thereby inhibiting any corrosion or oxidation of the hot stamped part of the metal surface.

In one embodiment, the precursor coating is coated onto the metal surface and then converted to a highly corrosion-resistant and oxidation-resistant coating, thereby making the precursor coating to be stable at high temperatures experienced during heat forming techniques. In one embodiment, the precursor coating to the composition onto the metal surface before pyrolysis comprises about 34 wt. % to about 94 wt. % polysilazane as a dry film coating. In one embodiment, the precursor coating to the composition onto the metal surface before pyrolysis comprises about 79 wt. % to about 88 wt. % polysilazane as a dry film coating. In one embodiment, the precursor coating to the composition onto the metal surface before pyrolysis comprises about 66 wt. % to about 6 wt. % aluminum metal as a dry film coating. In one embodiment, the precursor coating to the composition onto the metal surface before pyrolysis comprises about 31 wt. % to about 12 wt. % aluminum metal as a dry film coating.

In one embodiment, the present invention utilizes a method of performing hot stamping for sheet material. In one embodiment, pyrolysis is preferably accomplished during the hot stamping process. The hot stamping process serves to shape metal sheet. During hot stamping, the coating and metal are heated to temperatures at which both ductile forming of the metal under pressure occurs, and at which pyrolysis of the metal-containing, preceramic polymer to ceramic occurs, and then to temperatures at which disproportionation of the ceramic that is in direct contact with the metal surface occurs.

In one embodiment, the method comprises the following steps. At one step, a precursor coating composition is applied onto the surface of the steel material. At another step, the curable precursor coating composition is allowed to dry on the surface of the steel material. At another step, the coated steel material is hot stamped at a pre-defined temperature under a time and pressure conditions sufficient to pyrolyze precursor coating composition to form a protective coating on the surface of the steel material. In one embodiment, the coated steel material is hot stamped at a temperature ranging from about 750° C. to about 1,300° C. At another step, the coated metal surface is finally cooled. In one embodiment, the hot stamping forming is performed in a period of time of no more than 1 minute. In one embodiment, the hot stamping forming is performed at a controlled temperature ranging from bout 400-800° C. In one embodiment, during high temperature stamping, the surfaces of steel material are protected by roller-coating the surfaces to be stamped with a coating composition.

In one embodiment, the present invention utilizes a method of pyrolyzing the precursor coating applied on the metal surface. In one embodiment, the method comprises the following steps. At one step, the metal surface of a metal part is provided. In one embodiment, the metal part is a ferrous metal part. At another step, the precursor coating composition is applied. In one embodiment, the precursor coating composition comprises a preceramic polymer having a metal particulate to the surface of the ferrous metal part through a spray or dip coating application.

At another step, the sprayed or dip-coated coating is cured to a solid precursor-coating. At another step, the solid precursor-coating is pyrolyzed on the ferrous metal part. In one embodiment, the solid precursor-coating is pyrolyzed at a temperature ranging from about 750° C. to about 1,300° C. under an induced pressure. In one embodiment, the induced pressure may range from about 5 MPa to about 600 MPa. When the dispersions are used to provide protective ceramic coatings on substrates, the surfaces to be coated are usually cleaned prior to the application of the coating composition in order to improve the bonding of the ceramic coating to the substrate. In one embodiment, the bonding may sometimes be further improved by pre-etching the surfaces to be coated.

In one embodiment, the present invention utilizes a cost-effective, coil coating method for forming a shaped steel part. The method provides exceptional resistance to oxidation during the quenching step. In one embodiment, the method comprises the following steps. At one step, a coil of sheet steel is provided. In one embodiment, the sheet steel has a thickness ranging from about 0.25 mm to about 15.0 mm. At another step, a precursor coil coating is applied. In one embodiment, the precursor cool coating comprises a polysilazane, aluminum metal, and a solvent to the steel surface. In one embodiment, the precursor coil coating comprises a polysilazane, aluminum meta, an amine curing agent, and a solvent to the steel surface.

At another step, the solvent is flashed from the steel surface. At another step, the coated coil coating is cured to a solid precursor-coating. At another step, the sheet steel comprising the cured precursor-coating is heated through the application of heat at a pre-defined temperature. In one embodiment, the temperature may range from about 900° C. to about 1,100° C. At another step, the coated steel is shaped at a temperature ranging from about 800° C. to about 900° C. At another step, the coated steel is shaped at a temperature ranging from about 500° C. to about 850° C. under an induced pressure. In one embodiment, the induced pressure may range from about 15 MPa to about 600 MPa through a hot stamping process.

In one embodiment, the method utilizes coating precursor compositions comprising aluminum, either alone or in combination with polysilazane and a solvent or combination of metals. Optionally, other metallic and/or non-metallic components such as boron, silicon, and zinc may be used.

In one embodiment, the present invention provides for a polymer-derived composition for providing a ceramic-based precursor coating on a metal surface, comprising: one or more preceramic polymers admixed with one or more metal particulates, wherein the composition is integrally disposed on and within the metal surface of a metal part through pressure-assisted pyrolysis of a metal particulate-filled preceramic polymer under appropriate conditions, thereby providing a corrosion-resistant and oxidation-resistant metal surface.

In one embodiment, the present invention provides for a polymer-derived composition for providing a ceramic-based precursor coating on a metal surface, consisting essentially of: one or more preceramic polymers admixed with one or more metal particulates, wherein the composition is integrally disposed on and within the metal surface of a metal part through pressure-assisted pyrolysis of a metal particulate-filled preceramic polymer under appropriate conditions, thereby providing a corrosion-resistant and oxidation-resistant metal surface.

In one embodiment, the preceramic polymer comprises silicon. In another embodiment, the preceramic polymer is selected from the group consisting of polysilanes, polycarbosilanes, polysiloxanes, and polysilazanes. In another embodiment, the preceramic polymer is a polysilazane. In another embodiment, the metal particulate is selected from the group consisting of aluminum and silicon. In another embodiment, the metal particulate comprises a ratio of silicon (Si) to aluminum (Al) atoms between 0.25:1.75 and 1.75:0.25. In another embodiment, the metal particulate comprises a ratio of silicon (Si) to aluminum (Al) atoms between 0.50:1.50 and 1.50:0.50. In another embodiment, the polymer-derived composition comprises a SiAlON-containing ceramic material. ceramic material. In another embodiment, the polymer-derived composition consists essentially of a SiAlON-containing ceramic material. ceramic material. In another embodiment, the polymer-derived composition comprises polysilazane and aluminum metal particulate, wherein the polysilazane and aluminum metal particulate are used in sequential coil coating and hot stamping process. In another embodiment, the polysilazane and aluminum metal particulate react upon exposure to heat and pressure while preparing ceramic compositions. In another embodiment, the ceramic compositions react with the metal surface through a diffusion process to provide a composite coating.

In another embodiment, the composite coating includes aluminum oxides, ceramic inclusions, and ferrous alloys on the metal surface, thereby inhibiting any corrosion or oxidation of the hot stamped part of the metal surface. In another embodiment, the precursor coating is coated onto the metal surface and then converted to a highly corrosion-resistant and oxidation-resistant coating, thereby making the precursor coating to be stable at high temperatures experienced during heat forming techniques. In another embodiment, the precursor coating to the composition onto the metal surface before pyrolysis comprises about 34 wt. % to about 94 wt. % polysilazane as a dry film coating. In another embodiment, the precursor coating to the composition onto the metal surface before pyrolysis comprises about 79 wt. % to about 88 wt. % polysilazane as a dry film coating. In another embodiment, the precursor coating to the composition onto the metal surface before pyrolysis comprises about 6 wt. % to about 66 wt. % aluminum metal as a dry film coating. In another embodiment, the precursor coating to the composition onto the metal surface before pyrolysis comprises about 12 wt. % to about 31 wt. % aluminum metal as a dry film coating. In another embodiment, the metal part is a ferrous metal part that is selected from the group consisting of iron, steel, and stainless steel. In another embodiment, the metal part is in the form of a continuous metal sheet.

In one embodiment, the present invention provides for a method of performing hot stamping for sheet material, comprising: applying a precursor coating composition onto a surface of the steel material, wherein the precursor coating composition comprises one or more preceramic polymers admixed with one or more metal particulates, wherein the composition is integrally disposed on and within a metal surface of a metal part through pressure-assisted pyrolysis of a metal particulate-filled preceramic polymer under appropriate conditions, thereby providing a corrosion-resistant and oxidation-resistant metal surface, drying the precursor coating composition on the surface of the steel material; hot stamping the coated steel material at a pre-defined temperature under a time and pressure conditions sufficient to pyrolyze precursor coating composition to form a protective coating on the surface of the steel, and cooling the coated steel material.

In another embodiment, the present invention provides for a method of performing hot stamping for sheet material, consisting essentially of: applying a precursor coating composition onto a surface of the steel material, wherein the precursor coating composition comprises one or more preceramic polymers admixed with one or more metal particulates, wherein the composition is integrally disposed on and within a metal surface of a metal part through pressure-assisted pyrolysis of a metal particulate-filled preceramic polymer under appropriate conditions, thereby providing a corrosion-resistant and oxidation-resistant metal surface, drying the precursor coating composition on the surface of the steel material; hot stamping the coated steel material at a pre-defined temperature under a time and pressure conditions sufficient to pyrolyze precursor coating composition to form a protective coating on the surface of the steel, and cooling the coated steel material.

In another embodiment, the pressure-assisted pyrolysis comprising: applying a precursor coating composition comprising one or more preceramic polymers admixed with one or more metal particulates to the metal surface of a metal part through a spray or dip coating application; curing the sprayed or dip-coated coating to a solid precursor-coating, and pyrolyzing the solid precursor-coating on the metal part at a pre-defined temperature under an induced pressure. In another embodiment, the precursor coating composition reacts to form a ceramic coating comprising silicon, aluminum, oxygen, and nitrogen (a SiAlON). In another embodiment, the surface of the steel material is shaped through the hot stamping, comprising: applying a precursor coil coating to the surface of the steel material through a coil coating process; flashing a solvent from the surface of the steel material; curing the coated surface of the steel material with precursor coil coating to a solid precursor-coating; heating the surface of the steel material comprising the cured precursor coil coating through the application of heat, and shaping the coated surface of the steel material at a temperature under an induced pressure through the hot stamping. In another embodiment, the precursor coil coating comprises a polysilazane, aluminum metal, amine curing agent, and a solvent to the surface of the steel material.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a graph illustrating hardness of Nitrided AISI 430 stainless steel for various time instances, according to one embodiment of the present invention.

FIG. 2 shows a graph illustrating the distribution of atoms from an unreacted SiAlON region through a “diffusion” inter-layer and into a steel surface, according to one embodiment of the present invention.

FIG. 3 shows an optical micrograph image illustrating a diffusion layer that is present in a cross section of a SiAlON-Stainless Steel join reaction, according to one embodiment of the present invention.

FIG. 4 shows a method of hot stamping, according to one embodiment of the present invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

All publications, patents and patent applications cited herein, whether supra or infra, are hereby incorporated by reference in their entirety to the same extent as if each individual publication, patent, or patent application was specifically and individually indicated as incorporated by reference.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

### Definitions

As used in the present specification, the following words and phrases are generally intended to have the meanings as set forth below, except to the extent that the context in which they are used indicates otherwise.

As used herein, the term “preceramic polymer” refers to one of various polymeric compounds, which through pyrolysis under appropriate conditions are converted to ceramic compounds, having high thermal and chemical stability. Ceramics resulting from the pyrolysis of preceramic polymers are known as polymer derived ceramics, or PDCs. Typically, preceramic polymers contain silicon (Si) in the molecular backbone, with the resulting material containing Si. There are a wide variety of known preceramic polymers.

As used herein, the term “precursor coating” refers to a coating composition for metals comprising one or more preceramic polymer admixed with one or more metal particulate, wherein the composition is capable of forming a corrosion-resistant and oxidation-resistant composition integrally disposed on and within the surface of a metal through pyrolysis under appropriate conditions.

As used herein, the term “metal particulate” refers to metal particles added to the preceramic polymer composition. The metal particles are particles of one or more metals selected from the group consisting of aluminum, chromium, cobalt, copper, iron, manganese, nickel, titanium, vanadium, zinc, and zirconium. In another embodiment, the metal particles are particles of one or more metals selected from the group consisting of aluminum, magnesium, silicon, and zinc. Optionally, the metal particles additionally include particles of one or more metals selected from the group consisting of chromium and manganese. In another embodiment, the composition may optionally include additional non-metallic components of carbon and boron. These latter components are alloying metals/non-metal for 22MnB5 stainless steel alloy, which is a preferred grade of stainless steel used in hot stamping using such polysilazane/aluminum diffusion coatings. In one embodiment, the alloying metals/non-metal composition is particularly useful in automotive applications.

According to the present invention, a composition and a method for the production of the composition are disclosed. In one embodiment, the composition is a polymer-derived composition for providing a ceramic-based precursor coating on a metal surface. In one embodiment, the composition comprises one or more preceramic polymers admixed with one or more metal particulates. In one embodiment, the composition is integrally disposed on and within the metal surface of a metal part through pressure-assisted pyrolysis of a metal particulate-filled preceramic polymer under appropriate conditions, thereby providing a corrosion-resistant and oxidation-resistant metal surface. In one embodiment, the metal part is a ferrous metal part that is selected from the group consisting of iron, steel, and stainless steel. In one embodiment, the metal part is in the form of a continuous metal sheet.

In some embodiments, the preceramic polymers may be selected from a group comprising, but not limited to, borazine-modified hydridopolysilazanes, boropolycarbosiloxane, decaborane-based polymers, polyaluminocarbosilane, polyborazylene, polycarbosilanes, polycarbosilazanes, polysilacarbosilanes, polysilacarbosilazanes, polysilanes, polysilasilazane, polysilazanes, polysiloxazanes, polysilylcarbodiimides, polyvinylborazine, silicone resins, metal-modified preceramic polymers, and mixtures thereof. The polymeric preceramic precursor may be comprised of a polymer where the backbone is primarily comprised of C—C bonds, for example, polysilylcarbodiimides.

In one or more embodiments, the preceramic polymer is selected from the group consisting of borazine-modified hydridopolysilazanes, polycarbosilanes, polycarbosilazanes, polysilacarbosilanes, polysilacarbosilazanes, polysilanes, polysilasilazane, polysiloxazanes, polysilylcarbodiimides, silicone resins, and mixtures thereof. In another embodiment, the preceramic polymer further comprises one or more polymers selected from the group consisting of polyvinylborazine, polyborazylene, and decaborane-based polymers.

In one or more embodiments, the preceramic polymer comprises one or more of the following: polysiloxanes, polysilsesquioxanes, polycarbosiloxanes, polyborosilanes, polyborosiloxanes, polysilazanes, poly-silsesquiazanes, polyborosilazanes, polycarbosilanes, polysilylcarbodiimides, and polysilsesquicarbodiimides.

In another embodiment, the preceramic polymer comprises one or more of a polyacetal, a polyolefin, a poly(alkylene oxide), a poly(meth)acrylate, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a poly sulfonamide, a polyurea, a polysilazane, a polyethylene terephthalate, a polybutylene terephthalate, a polyurethane, an ethylene propylene diene rubber, a polytetrafluoroethylene, a fluorinated ethylene propylene, a perfluoroalkoxyethylene, a polychlorotrifluoroethylene, a polyvinylidene fluoride, or a combination thereof.

In another embodiment, the preceramic polymer is a silicon-containing preceramic polymer selected from the group consisting of polysilazanes, polycarbosilanes, polysiloxanes, polysilsesquioxanes, polysilanes, and mixtures thereof. In another embodiment, the silicon-containing preceramic polymer is a polysilazane. In another embodiment, the polysilazane is selected from the group consisting of hydridosilazanes, vinyl modified polysilazanes, silacyclobutasilazanes, vinyl modified poly(disilyl)silazanes, borosilazanes, boron modified hyrdopolysilazanes, vinyl-modified hydridopolysilazanes.

In one embodiment, the metal particulate is selected from the group consisting of aluminum and silicon. In some embodiments, the metal particulate is aluminum. In general, for aluminum, the smaller the particle the more active it towards ceramic formation. In an example formulation, HYDROLAN 501 is used as a source of metal particulate source of aluminum metal. In some embodiments, the HYDROLAN 501 has a particle size distribution as shown in below table 1, wherein the particle sizes are all less than 43 microns (325 mesh).

| Characteristics | Specification | Unit |
|---|---|---|
| TI00004 pigment content/non volatile | 58.0-62.0 | % |
| TI00004 volatile content | 38.0-42.0 | % |
| TI00005 sieving <40 μm | 99.9-100.0 | % |
| TI00033 aqueous paint spray-out | pass | |
| TI00489 D 10 | 8.0-12.0 | μm |
| TI00489 D 50 | 20.0-26.0 | μm |
| TI00489 D 90 | 35.0-43.0 | μm |

In the above example, 90% of the powder has a particle size between 35 and 43 microns, 50% of the powder has a particle size between 20 and 26 microns, and 10% of the powder has a particle size between 8 and 12 microns. In some embodiments, the HYDROLAN 501 powder is “protected” from air/moisture with a Silica-type coating. Hence, the “activity” of the HYDROLAN 501 is about 60%, not 100% because only about 60% of it is aluminum. In one embodiment, the 60 wt. % aluminum metal “activity” of the HYDROLAN is taken into consideration in the elemental percentages of the coatings recited below.

In one embodiment, a coil coating process is used to provide corrosion resistance to a coiled steel sheet. Various standard methods for coil coating process are quite efficient and produce a uniform, high quality, coated finish over metal in a continuous, automated fashion. The coil coating is also referred to as pre-painted metal as the metal is painted prior to, rather than after, fabrication.

In the coil coating process, the metal coil is first unwound, cleaned, and pre-treated. The pre-treated metal coil is then applied on a flat continuous sheet, heat cured, and cooled. Finally, the cooled flat continuous sheet is rewound for shipment. At the fabricator, the flat continuous sheet is cut to a desired size and formed into its finished shape. In most other application methods, coil coating efficiency is nearly 100%. In some embodiments, the application is at very high line speeds as modern coil lines, which may run at speeds as high as 700 feet per minute and cure the applied paint in 15-45 seconds. In one embodiment, coil primers/primer dry film and backers are normally applied much thinner than the spray-applied liquid or powder coatings, dip or electrocoat paints. In one embodiment, the applied primer dry film normally has a thickness in the range of about 4-6 microns, whereas topcoats are normally applied to provide a dry film thickness of 18-20 microns. In one embodiment, a variety of chemical compositions can be coil coated, which include, but not limited to, polyester amines, polyester urethanes, silicone modified polyesters, epoxy, vinyl, acrylic melamine, waterborne acrylic latex, and fluoropolymers.

While the coil coating process is a very cost-effective process, the coatings that are typically applied by means of this process are temperature-sensitive and cannot be heated to about 650° C. to about 1,300° C. temperatures required to perform a metal stamping process on a steel sheet. On the other hand, there are treatments whereby the surface of the steel can be chemically modified to make the steel harder and more corrosion and oxidation resistant. In such treatments, the chemistry of the surface of the steel itself is altered, thereby creating an alloy of iron and other elements that is more resistant to corrosion or oxidation than the body of the steel itself. Such treatments are not temperature sensitive, and thus represent a desirable method of imparting a variety of characteristics to the steel surface that still allows a high temperature (approximately 1,000° C.) process to be employed to shape the steel sheet. In one embodiment, the process is called “diffusion coating” process. The diffusion coating process typically introduces elements such as carbon (C) and nitrogen (N) into the top surface of the steel.

In one embodiment, diffusion coating is a process in which metal components, for example, steel, will be treated and exposed to corrosive or abrasive environments, typically at high temperatures. The diffusion coating process modifies the surface chemistry of the steel. In one embodiment, the diffusion coating process is normally done at elevated temperatures in a controlled chamber. In one embodiment, the diffusion coating process is a surface alloying process. In one embodiment, the diffusion coating process can be done using three processes such as Solid state diffusion, Liquid state diffusion, and Chemical vapor diffusion.

In one embodiment, the solid state diffusion is used to form an alloy of a base metal at its surface with another metal that is coated upon its surface. In solid state diffusion, the vapor pressure of the coating metal has to be lower than that of the base metal. The process is normally performed in a hermetically sealed container with the base metal covered with the powdered coating material. The container is then heated in a vacuum at a temperature ranging from about 1,000° C. to about 1,500° C. The coating metal melts to cover the entire surface of the base metal and alloys with its surface. In one embodiment, the solid-state diffusion process is also referred to as pack cementation.

In one embodiment, the liquid diffusion is performed in tank furnaces. In the tank furnaces, the diffusing metal interacts with the surface of the base metal in a liquid state at a temperature ranging from about 800° C. to about 1,300° C.

In one embodiment, in the chemical gas diffusion, the material that is used to alloy with the surface of the base metal is heated into a gaseous form at a distance from the surface being saturated. The gaseous chemical compounds of the coating element react with the basic metal, resulting in diffusion of the metal. This gaseous phase typically consists of metal halides to ensure sublimation of the diffusing metal on and into the surface of the base metal, but other gaseous forms of the element to be diffused into the base metal surface can be employed. In one embodiment, the chemical gas diffusion is usually performed in specially designed furnaces at a temperature ranging from about 700° C. to about 1,000° C. In one embodiment, the chemical gas diffusion process is also referred to as “out-of-contact gas phase diffusion”.

In one embodiment, the present invention utilizes two main techniques to modify the surface of the steel. The two techniques are gas carburizing and nitridation.

In one embodiment, the gas carburizing technique is carried out in a gaseous atmosphere containing carbon monoxide (CO) and methane (CH₄). The gas dissociates at the hot steel surface to generate elemental carbon atoms. This carbon then permeates the steel lattice to form a carbon-enriched surface layer. In one embodiment, the carburization process serves to “case-harden” the steel surface.

In one embodiment, the steel nitridation technique is carried out by diffusing nitrogen into the steel surface through exposure to nitrogen gas at relatively low temperatures.

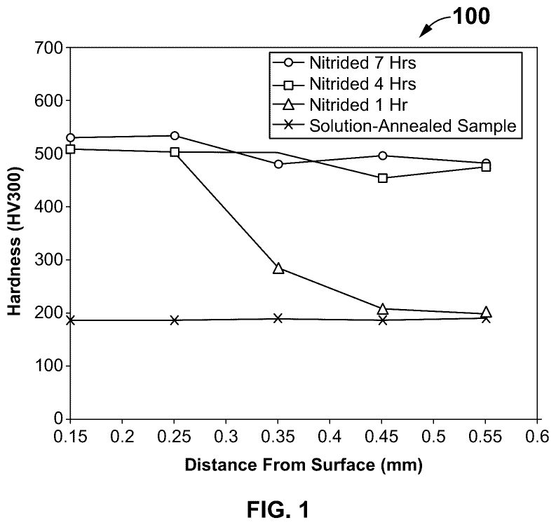

Referring to FIG. 1, a graph 100 showing an improved hardness of Nitride AISI 430 stainless steel for various times is illustrated. In one embodiment, in the steel nitridation technique, the steel surface is diffused with nitrogen through exposure to nitrogen gas at relatively low temperatures, for example, about 524° C. In the steel nitridation technique, some of the iron at the surface of the steel is converted to ferric nitride (FeN). The resulting ferric nitride inclusions harden the steel surface, thereby creating a highly wear resistant and more gall resistant surface than the underlying steel, which retains its softer, more ductile characteristics.

However, such diffusion processes, as those described above, are unsuitable for coiled metal surfaces such as sheet steel, due to the following reasons, such as time limitation and the requirement of confined space. The time required for the complete cure of a coil coating for coiled sheet steel is from about 30 seconds to about 90 seconds, which is being dispensed at a rate up to about 700 feet per minute. Also, the diffusion processes need to be performed in a confined space.

Therefore, there exists a need to identify a simple, cost-effective process to provide corrosion-resistance and oxidation-resistance to sheeted steel parts that undergo a hot stamping process. Such parts have special utility in the production of automotive parts such as crumple zones, b-pillars, a-pillars, and the like, which must be formed using a hot stamping process.

In one embodiment, the metal surface is shaped through a hot stamping process. The hot stamping process utilizes a polymer-derived composition for providing a ceramic-based precursor coating on the metal surface. In one embodiment, the precursor coating composition comprises one or more metal particulates. The precursor coating composition is applied onto the metal surface through a coil coating process. The surface coated with the precursor coating composition is then converted, through the action of heat, to a highly corrosion-resistant and oxidation-resistant coating that is stable at high temperatures and can withstand the high temperatures experienced during heat forming techniques such as hot stamping. In a preferred embodiment, the precursor coating composition is applied by way of a coil coating process, and thus expensive techniques such as dip-coating in molten metal are avoided.

In one embodiment, the precursor coating composition comprises one or more preceramic polymers. The preceramic polymers are admixed with the metal particulates. In one embodiment, the preceramic polymer is selected from the group consisting of polysilanes, polycarbosilanes, polysiloxanes, and polysilazanes. In one embodiment, the preceramic polymer is a polysilazane. Polysilazanes are polymers in which silicon and nitrogen atoms alternate to form the basic backbone. Since each silicon atom is bound to two separate nitrogen atoms and each nitrogen atom to two silicon atoms, both chains and rings of the formula [R¹R²Si—NR³]ₙ occur. R¹, R², and R³ can be hydrogen atoms or organic substituents. If all substituents R are H atoms, the polymer is designated as Perhydropolysilazane, Polyperhydridosilazane, or Inorganic Polysilazane [H₂Si—NH]ₘ. If hydrocarbon substituents are bound to the silicon atoms, the polymers are designated as Organopolysilazanes.

When polysilazanes are pyrolyzed, that is, heated to temperatures above about 750° C., they form silicon nitride, silicon carbonitride, or silicon oxycarbonitride ceramics, depending on the composition of the polysilazane as well as the pyrolysis atmosphere. Further, gaseous pyrolysis by-products such as ammonia (NH₃) and methane (CH₄) are produced during the pyrolysis process.

In one embodiment, the composition comprises both a polysilazane and aluminum metal particulate that can be used in a simple, sequential coil coating, and hot stamping process. In one embodiment, the elemental constituents comprising the coating composition react upon exposure to heat and pressure during the process to produce ceramic compositions. These ceramic compositions then react with the steel surface itself through a diffusion process to provide a composite coating. In one embodiment, the composite coating comprises aluminum oxides, ceramic inclusions, and ferrous alloys on the surface of the steel that acts to inhibit any corrosion or oxidation of the hot stamped part. The diffusion process makes the compositions as an integral part of the steel surface itself rather than simply providing a corrosion resistant coating that adheres to the surface of the steel.

In one embodiment, a sealed environment is provided to shape the steel sheet at the high temperatures. The sealed environment is provided by an enclosed pressure exerted in the hot stamping process. The sealed environment can retain gaseous moieties comprising both carbon (C) and nitrogen (N) at the base metal surface to allow for their diffusion into the surface of the steel sheet. The gaseous moieties, such as methane (CH₄) and ammonia (NH₃) are generated when a polysilazane is “pyrolyzed” to a ceramic material upon exposure to temperatures as low as about 750° C.

At the same time, the silicon (Si) component of the polysilazane polymer forms SiCN and Si(O)CN when exposed to atmospheric humidity. In one embodiment, the silicon (Si) component of the polysilazane polymer forms SiCN and Si(O)CN when pyrolyzed to temperatures of about 750° C. or above. In one embodiment, when polysilazane is filled with various aluminum-ceramic particulate such as aluminum oxide (Al₂O₃), a SiAlON ceramic is formed with the evolution of gaseous by-products which are mainly ammonia (NH₃) and methane (CH₄). SiAlON ceramics are based on the elements silicon (Si), aluminum (Al), oxygen (O) and nitrogen (N). In one embodiment, when polysilazane is filled with aluminum metal, a SiAlON or a Si(O)CN ceramic containing aluminum is also formed during pyrolysis.

In one embodiment, polysilazanes are extremely versatile reactive materials. The polysilazanes are used to form various ceramic compositions depending on the exact metal particulate used to co-react with the polysilazane. For instance, when a polysilazane is filled with titanium metal powder and is pyrolyzed, a titanium nitride (TiN) and silicon carbide (SiC) ceramics are formed. Alternatively, when it is filled with molybdenum metal powder and pyrolyzed, molybdenum silicide (Mo₅Si₃) ceramic results.

In one embodiment, the pyrolytic reaction of a polysilazane with aluminum metal to form SiAlON prior to its disproportionation to generate the novel coating compositions of the invention is of particular significance. The SiAlONs undergo the solid-state diffusion reaction when heated in contact with the steel at temperatures between 650° C. and 1,300° C. The SiAlON provides silicon, nitrogen, and carbon to underlying steel surfaces through both a gaseous and a solid-state diffusion process with the formation of various iron silicide (FeSi) and iron nitride (FeN) inclusions within the surface of the steel.

Similarly, depletion of these elements within the SiAlON ceramic itself then results in the formation of aluminum oxides (Al₂O₃) at the air interface. If the depletion is not contained in a sealed environment, the nitrogen present in the SiAlON is lost as nitrogen gas at temperatures of less than about 1035° C., whereas the nitrogen reacts with the iron in the steel surface to form iron nitride inclusions (FeN) at temperatures of more than about 1035° C. On the other hand, when such disproportionation of SiAlON occurs in a sealed environment, iron nitride formation can occur.

Concurrently, the ammonia (NH₃) and methane (CH₄) by-products of the pyrolysis of the polysilazane can undergo gas-phase diffusion into the metal surface to similarly form iron nitrides (FeN) inclusions and, additionally, iron carbides such as cementite (Fe₃C). In one embodiment, the iron nitrides (FeN) and iron carbides (Fe₃C) contribute to the hardness of the metal surface.

In one embodiment, the present invention utilizes a method to treat steel in a spray or coil coating and stamping process. The method utilizes a variety of ferrous metal compositions, ranging from cast iron through mild steel and stainless steel, regardless of the alloying elements that are present in the steel.

Thus, the aluminum metal-filled polysilazane compositions serve only as precursor compositions to the actual corrosion-resistant and oxidation-resistant coating, which is only formed upon disproportionation of the SiAlON that is formed when a temperature of about 750° C. or greater is reached during a hot stamping process. The SiAlON ceramic is then disproportionated to provide both aluminum oxides (Al₂O₃) at the air interface of the composite coating as well as iron silicide (FeSi) and iron nitrides (FeN) at the metal interface of the composite coating.

While the exact chemistry that occurs at the steel surface is complex and cannot be fully described within the limited scope of this specification, the particular utility in the practice of the present invention resides in the fact that such chemistries can be imparted to steel surfaces by simply coil coating and hot stamping techniques. The precursor compositions to SiAlON, which are aluminum metal particulate-filled liquid polysilazanes optionally comprising solvent, can be sprayed onto the surface of a steel sheet to form a continuous coating. The continuous coating is cured to a solid “precursor coating” in a short period of time (30 seconds to 90 seconds), and then subsequently pyrolyzed to the reactive SiAlON composition at temperatures of about 750° C. or above. The resulting disproportionation of the SiAlON ceramic forms the corrosion-resistant and oxidation-resistant coating.

In some embodiments, the precursor coating is pyrolyzed at a temperature ranging from about 650° C. to about 1,300° C. In some embodiments, the precursor coating is pyrolyzed at a temperature ranging from about 675° C. to about 1250° C. In some embodiments, the precursor coating is pyrolyzed at a temperature ranging from about 675° C. to about 1100° C. In some embodiments, the precursor coating is pyrolyzed at a temperature ranging from about 675° C. to about 900° C.

In some embodiments, the present invention utilizes a temperature of about 750° C. or above. For a variety of reasons, including ease of hot stamping, it is desirable to use hot stamping temperatures ranging from about 700° C. to about 1,300° C. In a preferred embodiment, the hot stamping process utilizes a temperature ranging from about 800° C. to about 1,200° C. In more preferred embodiment, the hot stamping process utilizes a temperature ranging from about 900° C. to about 1,100° C.

In one embodiment, the present invention utilizes a method of pyrolyzing the precursor coating applied on the metal surface. In one embodiment, the method comprises the following steps. At one step, the metal surface of a metal part is provided. In one embodiment, the metal part is a ferrous metal part. At another step, the precursor coating composition is applied. In one embodiment, the precursor coating composition comprises a preceramic polymer having a metal particulate to the surface of the ferrous metal part through a spray or dip coating application.

At another step, the sprayed or dip-coated coating is cured to a solid precursor-coating. At another step, the solid precursor-coating is pyrolyzed on the ferrous metal part. In one embodiment, the solid precursor-coating is pyrolyzed at a temperature ranging from about 750° C. to about 1,300° C. under an induced pressure. In one embodiment, the induced pressure may range from about 5 MPa to about 600 MPa. When the dispersions are used to provide protective ceramic coatings on substrates, the surfaces to be coated are usually cleaned prior to the application of the coating composition in order to improve the bonding of the ceramic coating to the substrate. In one embodiment, the bonding may sometimes be further improved by pre-etching the surfaces to be coated.

In one embodiment, the coating compositions may be applied to the substrates in any suitable manner, such as by spraying, swabbing, or brushing, to form coatings having the desired thickness. In one embodiment, the thickness is about 1000 micrometers. In one embodiment, the thickness may be about 10-250 micrometers. In one embodiment, a desired thickness of the coating is achieved by applying a single coating of that thickness or by applying the precursor coating composition in multiple thinner layers. For example, applying the coating composition in layers of about 25-100 micrometers, each layer being dried by driving off the solvent before the next layer is applied.

In some embodiments, the coating composition is applied at about 0.4 mils of dry film thickness after curing and before pyrolysis. A “mil” being a measurement that equals one-thousandth of an inch, or 0.001 inch. In another embodiment, the coating composition is applied at about 0.3 to about 0.6 mils of dry film thickness after curing and before pyrolysis. In another embodiment, the coating composition is applied at about 0.2 to about 0.8 mils of dry film thickness after curing and before pyrolysis. In another embodiment, the coating composition is applied at about 0.1 to about 1 mils of dry film thickness after curing and before pyrolysis.

In one embodiment, the present invention utilizes a cost-effective, coil coating method for forming a shaped steel part. The method provides exceptional resistance to oxidation during the quenching step. In one embodiment, the method comprises the following steps. At one step, a coil of sheet steel is provided. In one embodiment, the sheet steel has a thickness ranging from about 0.25 mm to about 15.0 mm. At another step, a precursor coil coating is applied. In one embodiment, the precursor cool coating comprises a polysilazane, aluminum metal, and a solvent to the steel surface. In one embodiment, the precursor coil coating comprises a polysilazane, aluminum meta, an amine curing agent, and a solvent to the steel surface.

At another step, the solvent is flashed from the steel surface. At another step, the coated coil coating is cured to a solid precursor-coating. At another step, the sheet steel comprising the cured precursor-coating is heated through the application of heat at a pre-defined temperature. In one embodiment, the temperature may range from about 900° C. to about 1,100° C. At another step, the coated steel is shaped at a temperature ranging from about 500° C. to about 850° C. under an induced pressure. In one embodiment, the induced pressure may range from about 100 MPa to about 600 MPa through a hot stamping process.

In one embodiment, the method utilizes coating precursor compositions comprising aluminum, either alone or in combination with polysilazane and a solvent or combination of metals. Optionally, other metallic and/or non-metallic components such as boron, silicon, and zinc may be used.

In some embodiments, the hot stamping temperature may range from about 400° C. to about 1,500° C. In a preferred embodiment, the hot stamping temperature may range from about 500° C. to about 1,200° C. In more preferred embodiment, the hot stamping temperature may range from about 600° C. to about 1,000° C. In another embodiment, the hot stamping temperature is at least 300, 350, 400, 450, 500, 550, 600, 650, 675, 700, 725, 750, 775, 800, 825, 850° C. or more. In another embodiment, the hot stamping temperature is at most 1800, 1700, 1600, 1500, 1400, 1300, 1200, 1100, 1000, 900, 875, 850, 825, 800, 775, 750° C. or less.

In one embodiment, the precursor coating compositions that are spray coated or coil coated onto the steel or stainless-steel surfaces comprise about 35 wt. % to 75 wt. % of a polysilazane, about 25 wt. % to 55 wt. % of aluminum, and about 0 wt. % to 30 wt. % of an organic solvent. In one embodiment, the precursor coating compositions that are spray coated or coil coated onto the steel or stainless-steel surfaces comprise about 35 wt. % to 60 wt. % of a polysilazane, about 25 wt. % to 35 wt. % of aluminum, and about 10 wt. % to 25 wt. % of an organic solvent.

In the above compositions it is important that the polysilazane content and aluminum metal content be sufficient to supply adequate silicon (Si), nitrogen (N), and aluminum (Al) to the pyrolysis product of the precursor coating so as to generate an adequate amount of SiAlON to prove effective in the formation of the final, diffusion-generated coating. Thus, a minimum amount of about 35 wt. % polysilazane and about 25 wt. % aluminum metal or greater are required.

In some embodiments, the precursor coating compositions comprise at least 15, 20, 25, 30, 35 wt. % polysilazane or more. In some embodiments, the precursor coating compositions comprise at most 85, 75, 65, 55, 50, 45, 40, 35 wt. % polysilazane or less. In some embodiments, the precursor coating compositions comprise at least 10, 15, 20, 25 wt. % aluminum metal or greater. In some embodiments, the precursor coating compositions comprise at most 65, 55, 50, 45, 40, 35, 25 wt. % aluminum metal or less. In some embodiments, the precursor coating compositions comprise at least 0, 1, 2, 5, 10 wt. % organic solvent or greater. In some embodiments, the precursor coating compositions comprise at most 65, 60, 55, 50, 45, 40, 35, 30, 25 wt. % organic solvent or less.

In some embodiments, the coating compositions taught herein comprise 30 wt. % to 60 wt. % of an aromatic organic solvent, 20 wt. % to 60 wt. % of a polysilazane, 0.5 wt. % to 5% wt. % of a catalyst, 5 wt. % to 25 wt. % of an aluminum source, including aluminum metal, and 5 wt. % to 25 wt. % of an organophosphorus compound.

In some embodiments, the organophosphorus compound is an aromatic organophosphorus compounds having at least one organic aromatic group and at least one phosphorus-containing group, or an organic compound having at least one phosphorus-nitrogen bond. In another embodiment, the aromatic organophosphorus compound comprises a C3-30 aromatic group and a phosphate group, phosphite group, phosphonate group, phosphinate group, phosphine oxide group, phosphine group, phosphazene, or a combination comprising at least one of the foregoing phosphorus-containing groups.

In another embodiment, the organophosphorus compound containing a nitrogen-phosphorus bond is a phosphazene, phosphorus ester amide, phosphoric acid amide, phosphonic acid amide, phosphinic acid amide, tris(aziridinyl)phosphine oxide, a combination comprising at least one of the foregoing. In another embodiment, the organophosphorus compound containing a nitrogen-phosphorus bond is a phosphazene. In another embodiment, the organophosphorus compound is effective to provide phosphorus in an amount of 0.1% to 1% of phosphorus, based on the weight of the composition. Phosphazenes refer to classes of organophosphorus compounds featuring phosphorus(V) with a double bond between P and N. One class of phosphazenes has the formula R—N═P(—NR₂)₃. These phosphazenes are also known as iminophosphoranes and phosphine imides.

In another embodiment, the phosphazene compound comprises at least one phosphorus atom and at least four nitrogen atoms. The nitrogen atoms are bound to the phosphorus atom. It is preferred that the phosphazene compound comprises at least one N═P double bond, preferably one, two, three or four N═P double bonds. In one embodiment, the phosphazene compound has a molecular weight in the range from 150 to 1,000 g/mol. In a preferred embodiment, the phosphazene compound has a molecular weight in the range from 180 to 900 g/mol. In a more preferred embodiment, the phosphazene compound has a molecular weight in the range from 200 to 800 g/mol. In a most preferred embodiment, the phosphazene compound has a molecular weight in the range from 220 to 750 g/mol. In another embodiment, the phosphazene compound is 2-tert-butylimino-2-diethylamino-1,3-dimethylperhydro-1,3,2-diazaphosphorine.

In one embodiment, the precursor coating compositions comprise about 0.1 wt. % to about 7.5% wt. % catalyst. In another embodiment, the precursor coating compositions comprise about 0.5 wt. % to about 5% wt. % catalyst. In another embodiment, the precursor coating compositions comprise about 1 wt. % to about 5% wt. % catalyst. In another embodiment, the precursor coating compositions comprise about 1 wt. % to about 3% wt. % catalyst. In some embodiments, the precursor coating compositions comprise at least 0. 0.1, 0.2, 0.3, 0.4, 0.5 wt. of a catalyst or more. In some embodiments, the precursor coating compositions comprise at most 10, 9, 8, 7, 6, 5, 4, 3, 2, 1, 0.5 wt. of a catalyst or less.

In one embodiment, the precursor coating compositions comprise about 0.5 wt. % to about 35% wt. % preceramic polymers. In another embodiment, the precursor coating compositions comprise about 1 wt. % to about 25% wt. % preceramic polymers. In another embodiment, the precursor coating compositions comprise about 5 wt. % to about 25% wt. % preceramic polymers. In another embodiment, the precursor coating compositions comprise about 15 wt. % to about 25% wt. % preceramic polymers. In some embodiments, the precursor coating compositions comprise at least 0.5, 1, 2, 5, 10, 20, 25, 30, 35, 40, 45, 50, 55, 60, 65, 70, 75 wt. % of preceramic polymers or more. In some embodiments, the precursor coating compositions comprise at most 75, 70, 65, 60, 55, 50, 45, 40, 35, 30, 25, 20, 15, 10, 9, 8, 7, 6, 5, 4, 3, 2, 1, 0.5 wt. % of preceramic polymers or less.

In some embodiments, the ratio of polysilazane to aluminum metal is about 0.25:1.75 to 1.75:0.25. In another embodiment, the ratio of polysilazane to aluminum metal is about 0.50:1.50 to 1.50:0.50 silicon metal to aluminum metal. Based on the average molecular weight of polysilazanes (64.2 g/mol for Durazane 1800) and the atomic weight of aluminum (27.0 g/mol), 1 mol of silicon metal and 1 mol of aluminum metal are obtained from 64.2 grams of Durazane 1800 and 27.0 grams of aluminum metal (not the 50%-70% aluminum metal contained in the Hydrolan). This weight ratio is then 64.2/27.0 or 2.8. Therefore, 2.8 times the amount of aluminum by weight of the Durazane 1800 to get a 1:1 ratio of silicon metal to aluminum metal. In some embodiments, the dry film composition (no solvent) comprises a ratio of 0.25 moles of silicon metal to 1.75 moles of aluminum metal, which would yield a weight ratio of (64.2 g polysilazane)×0.25=16.05 g polysilazane to (27.0 g Al metal)×1.75=47.25 g Al metal. This weight ratio is 16.0/47.25=0.34. The flip side of that ratio is (64.2 g polysilazane)×1.75=112.4 g polysilazane to (27.0 g Al metal)×0.25=6.75 g aluminum metal, or 112.4/6.75=16.7. In another embodiment, the dry film ratio of silicon to aluminum would represent ratios of polysilazane to aluminum meta weight ratio of 0.34 to 16.7. In another embodiment, using the ranges of 0.50 to 1.50 and 1.50 to 0.50 of polysilazane to aluminum metal, the ratio comes to 0.79 to 7.13.

In another embodiment, the dry film ratio of silicon to aluminum is 34 wt. % to 94 wt. % polysilazane, 66 wt. % to 6 wt. % aluminum metal [0.34 to 16.7]. In another embodiment, the dry film ratio of silicon to aluminum is 79 wt. % to 88 wt. % polysilazane, 31 wt. % to 12 wt. % aluminum metal [0.79 to 7.13]. A 1:1 ratio of silicon to aluminum metal would be 64.2 g polysilazane to 27.0 g aluminum metal, or 2.4. This comes to 71 wt. % polysilazane to 31 wt. % aluminum metal.

In another embodiment, the dry film compositions of precursor coating that are spray coated or coil coated onto the steel or stainless-steel surfaces comprise about: 34 wt. % to 94 wt. % polysilazane and 66 wt. % to 6 wt. % aluminum metal based on the total amount of polysilazane and aluminum metal contained in the coating.

In another embodiment, the dry film compositions that are spray coated or coil coated onto the steel or stainless-steel surface comprise about 79 wt. % to 88 wt. % polysilazane and about 31 wt. % to 12 wt. % aluminum metal based on the total amount of polysilazane and aluminum metal contained in the coating.

In another embodiment, the dry film compositions that are spray coated or coil coated onto the steel or stainless-steel surface comprise about 71 wt. % polysilazane and about 31 wt. % aluminum metal based on the total amount of polysilazane and aluminum metal contained in the coating. For example, a 2:1 weight ratio of Durazane 1800 to Hydrolan 501 that represents about 66 wt. % polysilazane to 34 wt. % Hydrolan as a “100%” composition, or 66 grams of polysilazane to 34 grams of Hydrolan. Optionally, an amine catalyst can be added to the above precursor coating compositions in amount of 0.5 wt. % to about 5 wt. % to accelerate cure of the coating on the metal surface. In another embodiment, the catalyst is selected from the group consists of acetonates, beta-diketonates, and carboxylates.

In some embodiments, the polysilazanes are polymers comprised of silicon and nitrogen. In some embodiments, the polysilazane may be an organopolysilazane or a perhydropolysilazane (inorganic polysilazane). In one embodiment, one or more suitable organic solvents may be either unsubstituted or substituted with heteroatom constituents. The organic solvents may be aliphatic or aromatic organic solvents. Further, one or more aromatic solvents are preferred, but any suitable organic solvent, such as hexane, heptane, and other aliphatic hydrocarbons; benzene, toluene, xylene, mesitylene, and other aromatic hydrocarbons; cyclohexanone, 1-methyl-2-pyrrolidone, and other ketones; etc.; and mixtures thereof.

In some embodiments, other solvents, such as the boroxine may be employed for the polysilazane. Optionally, any suitable organic solvents are preferred, which include, but not limited to, hexane, heptane, and other aliphatic hydrocarbons; benzene, toluene, xylene, and other aromatic hydrocarbons; cyclohexanone, 1-methyl-2-pyrrolidone, and other ketones; etc.; and mixtures thereof.

According to the present invention, particular examples of the solvent include at least one of (a) aromatic compounds, such as benzene, toluene, xylene, ethylbenzene, diethylbenzene, trimethylbenzene, triethylbenzene, or the like, (b) saturated hydrocarbon compounds, such as n-pentane, i-pentane, n-hexane, i-hexane, n-heptane, i-heptane, n-octane, i-octane, n-nonane, i-nonane, n-decane, i-decane, or the like, (c) alicyclic hydrocarbon compounds, such as ethyl cyclohexane, methyl cyclohexane, cyclohexane, cyclohexene, p-menthane, decahydronaphthalene, dipentene, limonene, or the like, (d) ethers, such as dipropyl ether, dibutyl ether, diethyl ether, methyl tert-butyl ether, anisole, or the like, and (e) ketones, such as methyl isobutyl ketone, or the like, and at least one of them may be used. When using a solvent, such as acetone, having a high-water content as the second solvent, the ceramic precursor may react with water in the precursor solution or in the slurry for a heat resistant layer, undesirably. Therefore, it is preferred to use the above-described solvents including no water or having a low water content as the second solvent.

In some embodiments, the solvent used for the methods of the present invention is an aromatic organic solvent selected from one or more solvents such as 1,2-diethylbenzene, 1,3-diethylbenzene, 1,4-diethylbenzene, 1,2,3-trimethylbenzene, 1,2,4-trimethylbenzene, 1,3,5-trimethylbenzene, polyethylbenzene, bicyclo[4.4.0]deca-1,3,5,7,9-pentaene, 2-methylindole, and 2-phenylpropane.

The pre-ceramic resins that are useful for making the compositions disclosed herein, generally have a viscosity of at least about 20 centipoise (cps) at about 25° C. such as greater than about 20 cps, greater than about 50 cps, greater than about 100 cps, greater than about 200 cps, greater than about 300 cps, greater than about 400 cps, or even greater than about 450 cps at about 25° C. However, both more and less viscous materials can be employed. While the resins may flow freely without added solvent, the viscosity can be reduced, if desired, by the addition of an organic solvent, such as an aromatic hydrocarbon solvent, for example, toluene or xylene, an aliphatic hydrocarbon solvent, such as heptane, decane, or dodecane, an ether solvent, such as tetrahydrofuran or anisole, an ester solvent, such as hexyl acetate or butyl propionate, or a ketone solvent such as acetone, methylethylketone, and the like.

In one embodiment, the present invention utilizes one or more cure catalysts. In one embodiment, the cure catalysts may include, but are not limited to organoheterocyclic compounds. In a preferred embodiment, the cure catalysts may be nitrogen-containing organoheterocyclic compounds. In more preferred embodiment, the cure catalysts may be fused cyclic organoheterocyclic compounds comprising multiple tertiary nitrogen atoms, such as diazabicyclo[5.4.0]undec-7-ene [“DBU”].

While the above precursor coating compositions are representative of those that are useful in the practice of the invention, the most important consideration resides in the ratio of polysilazane to aluminum metal that is present in the precursor coating compositions. While beta-SiAlON ceramics comprise a variety of compositions defined as Si6-zAlzOzN8-z, wherein z=0 to 4.2. Commercial grade beta-SiAlONs such as “Syalon 401”, are based on an approximate ratio of constituents wherein z=3. Syalon 401 thus has a composition defined as Si3Al3O3N5, wherein the ratio of silicon to aluminum atoms is 1:1. In a preferred embodiment, the optimum precursor coating compositions of the present invention comprise a ratio of silicon atoms to aluminum atoms that approximates 1:1. In this regard, the optimum precursor coating compositions represent polysilazane-aluminum metal compositions which pyrolyze to well-defined beta-SiAlON ceramic compositions.

Thus, suitable precursor coating compositions that are spray coated or coil coated onto the steel or stainless-steel surfaces comprise compositions having the ratio of silicon (Si) to aluminum (Al) atoms between 0.25:1.75 and 1.75:0.25. In one embodiment, the ratio of optimum precursor coating compositions that are spray coated or coil coated onto the steel or stainless-steel surfaces comprise compositions having the ratio of silicon (Si) to aluminum (Al) atoms is between 0.50:1.50 and 1.50:0.50.

In some embodiments, during a hot stamping process for sheeted steel, as the steel is configured to a desired shape of the coil coated, coating precursor composition reacts to form a ceramic coating comprising silicon, aluminum, oxygen, and nitrogen (a SiAlON). The pyrolysis process results in the evolution of gaseous carbonaceous and nitrogenous compounds that are incorporated into the metal surface as iron carbides and iron nitrides. The SiAlON ceramic that is formed then disproportionate while in contact with the steel surface to form a corrosion-resistant and oxidation-resistant composite coating. In one embodiment, an aluminum oxide (Al₂O₃) surface is formed and is integrally bonded to the hot stamped metal sheet.

The oxygen for the ceramic is supplied through handling in an open-air environment, since polysilazanes are moisture susceptible and react with water vapor in the air to generate polysiloxazane materials. Alternatively, the oxygen can be supplied by intentionally adding an oxygen containing component to the coating composition. such as aluminum acetyl acetonate [Al(acac)₃]. This component can either be an organic or an inorganic component, but is preferably an inorganic, ceramic component such as boron oxide (B₂O₃) or silicon dioxide (SiO₂) that can be incorporated into the ceramic composition as it forms on the surface of the metal. Each of these can contribute to the final performance characteristics of the steel. For instance, silica can provide additional silicon atoms for diffusion into the steel as well as oxygen to form aluminum oxide (Al₂O₃) in the final composition. Boron oxide can provide low temperature melting glassy phases such as borosilicate glasses (65-80% SiO₂/8-25% B₂O₃/Na₂O˜4%) which can assist in densification of the ceramic phases.

The disposition of the various ceramic components in the final product is dictated by the propensity of their constituent elements to either migrate into the metal surface or remain as a separate phase above the metal surface. In the case of SiAlON, studies have shown that the silicon in the SiAlON will migrate into a steel surface to form iron silicides (FeSi) when it is in contact with the metal and heated to temperatures of above about 620° C. If that temperature is below about 1,300° C., the nitrogen present in the SiAlON will leave as nitrogen gas. On the other hand, if that temperature is above about 1,300° C., the nitrogen will migrate into the steel surface to form iron nitrides (FeN), a hard and abrasion-resistant ceramic phase.

Concurrently, the carbon (C) component of the polysilazane is evolved as, primarily, methane gas (CH₄) that is held to the surface of the sheeted steel through the stamping process and can therefore diffuse into the surface of the steel to form iron carbide phases such as cementite (Fe₃C), another hard and abrasion resistance ceramic phase. Similarly, some of the nitrogen (N) component of the polysilazane is evolved as, primarily, ammonia gas (NH₃), that can diffuse into the surface of the steel to form iron nitride phases (FeN).

As these elements migrate into the steel, the aluminum and oxygen components are then depleted of silicon, nitrogen, and carbon and form a protective layer of aluminum oxide (Al₂O₃) at the air interface that is integrally incorporated into an underlying diffusion layer that comprises the iron silicides, iron nitrides, and iron carbides that are formed in the high temperature stamping process. The resulting material thus comprises a composition that is a gradient of various elements that are present as different ceramic or alloying phases, with silicon enriched phases predominating within and close to the surface of the steel and aluminum rich phases predominating at the air interface.

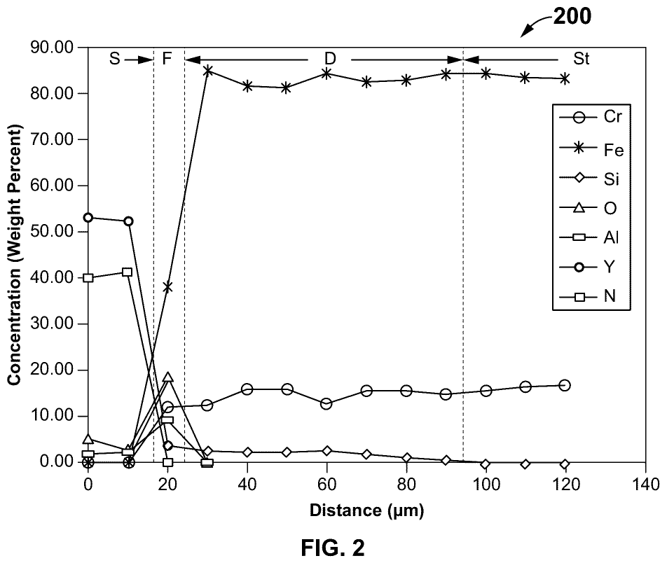

Referring to FIG. 2, a graph 200 showing the distribution of atoms from an unreacted SiAlON region through a “diffusion” inter-layer and into a steel surface is illustrated. With regards to this gradient effect within the layers of the final surface composition, a steel sheet is sandwiched between two SiAlON sheets and heated to temperatures of between 620° C. and 1,300° C. In the process of heating the SiAlON components are adhered together as migration of the silicon, aluminum, oxygen, and nitrogen atoms occurs to generate regions that are rich in one or more of the elements of the dissolute SiAlON and depleted in others. In the process silicon atoms migrate into the steel sheet to form iron silicides and aluminum atoms remain in a silicon depleted region in the form of aluminum oxide. Depending on the temperature, nitrogen may also migrate into the steel surface to form iron nitrides. The resulting, bonded composition shows the distribution of atoms from the unreacted SiAlON region through a “diffusion” interlayer and into the steel surface, wherein S=SiAlON, F=Interface Layer, D=Diffusion Layer, and St=Steel.

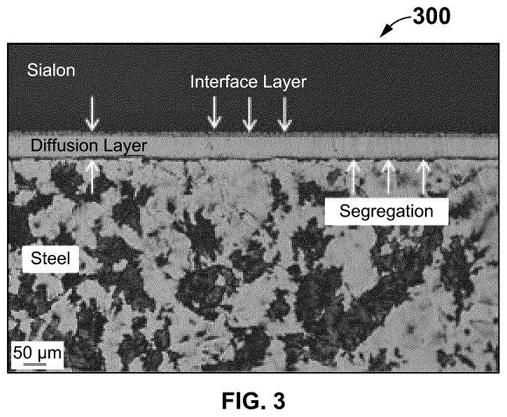

Referring to FIG. 3, an optical micrograph image 300 showing a diffusion layer that is present in a cross section of a SiAlON-Stainless Steel join reaction is illustrated. The presence of silicon and nitrogen in the diffusion layer that extends into the steel sheet can easily be seen in FIG. 2.

In one embodiment, the composite composition with its associated diffusion layer is formed when a coating that forms SiAlON or a similar ceramic is formed from a metal-containing silicon-based preceramic polymer and is then pyrolyzed under pressure at the surface of any ferrous metal, including iron, steel, and stainless steel. In one embodiment, pyrolysis of the coating can be accomplished through any of a number of techniques, including pressurized gas, or a mechanical press to which is fixtured a heated platen.

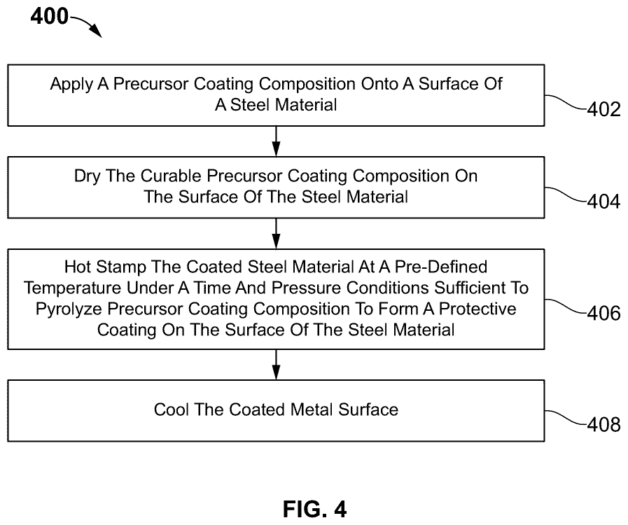

Referring to FIG. 4, a method 400 of the hot stamping is illustrated. In one embodiment, pyrolysis is preferably accomplished during the hot stamping process. The hot stamping process serves to shape metal sheet. During hot stamping, the coating and metal are heated to temperatures at which both ductile forming of the metal under pressure occurs, and at which pyrolysis of the metal-containing, preceramic polymer to ceramic occurs, and then to temperatures at which disproportionation of the ceramic that is in direct contact with the metal surface occurs.

In one embodiment, the method 400 comprises the following steps. At step 402, a precursor coating composition is applied onto the surface of the steel material. At step 404, the curable precursor coating composition is allowed to dry on the surface of the steel material. At step 406, the coated steel material is hot stamped at a pre-defined temperature under a time and pressure conditions sufficient to pyrolyze precursor coating composition to form a protective coating on the surface of the steel material. In one embodiment, the coated steel material is hot stamped at a temperature ranging from about 750° C. to about 1,300° C. In another embodiment, the coated steel material is hot stamped at a temperature ranging from about 800° C. to about 1,000° C. In another embodiment, the coated steel material is hot stamped at a temperature ranging from about 800° C. to about 900° C. At step 408, the coated metal surface is finally cooled. In one embodiment, the hot stamping forming is performed in a period of time of no more than 1 minute. In one embodiment, the hot stamping forming is performed at a controlled temperature ranging from bout 400-900° C. In one embodiment, during high temperature stamping, the surfaces of steel material are protected by roller-coating the surfaces to be stamped with a coating composition.

In one embodiment, the novel compositions are corrosion-resistant and oxidation-resistant compositions. The composition may be disposed on and within the surface of a ferrous metal part formed by the method comprising the pressure-assisted pyrolysis of a metal particulate-filled preceramic polymer.

In one embodiment, the compositions comprise aluminum-rich oxides (Al₂O₃) at the air interface of the steel surface. In one embodiment, the compositions further comprise silicon-rich and nitrogen-rich iron inclusions such as iron silicides (FeSi) and iron nitrides (FeN) at the coating-metal interface as well as within the bulk of the metal part at the metal-coating interface. Such iron silicide (FeSi) and iron nitride (FeN) phases are distinguishing features in the coating compositions of the instant invention and are not present when other processes using steel components simply dip coated in aluminum metal or an aluminum metal alloy are hot stamped. The nitrogen derives from the ammonia (NH₃) and other silicon-nitrogen components formed upon polycondensation and pyrolysis of the polysilazane which is the resinous binder component of the coating compositions. Such iron nitride (FeN) phases are particularly desirable, as mentioned above, in contributing to the improved hardness of the pyrolyzed coating.

Similarly, carbon-containing gases such as methane (CH₄) which are evolved in the pyrolysis of the preceramic polymer composition, diffuse into the steel surface and form iron carbides such as cementite (Fe₃C), which is, similarly, not present in processes involving the hot stamping of aluminum metal coated steel through a dipping process into the molten metal.

In one embodiment, an application in which they find particular utility is as coating compositions for normally oxidizable materials, especially those which need protection from oxidative deterioration at elevated temperatures. Such materials include oxidizable metals, such as iron, steel, stainless steel, magnesium, aluminum, silicon, niobium, molybdenum, lanthanum, hafnium, tantalum, tungsten, titanium, metals of the lanthanide and actinide series, and alloys thereof.

In some embodiments, the novel compositions formed comprise coatings that are formed on the surface of a metal selected from the group consisting of steel and stainless steel. In a preferred embodiment, the novel compositions formed comprise coatings that are formed on the surface of steel comprising a boron component, such as 22MnB5 steel. In one embodiment, a land motor vehicle comprises the novel compositions.

The control system for a hydraulic hot-stamping press should be capable of fully programmable and repeatable tonnage control to optimizes the process and reduce energy consumption. The press should be able to produce enough tonnage to form the part and hold/harden it, but excessive tonnage should be avoided. Tonnage that is applied beyond what is required may cause excess energy consumption and tooling wear. A typical range for hot stamping tonnage is between 400 and 2500 tons. In one embodiment, the hot stamping tonnage is between 450 and 1500 tons. In another embodiment, the hot stamping tonnage is at least 400, 425, 450, 475, 500, 525, 550, 575, 600 tons or more. In one embodiment, the hot stamping pressure is 400-800 MPa. In another embodiment, the hot stamping pressure is 450-700 MPa. In another embodiment, the hot stamping pressure is at least 400, 425, 450, 475, 500, 525, 550, 575, 600 MPa or more. In some embodiments, the pressure holding time of the hot stamping forming is about 1-300 seconds, and the stamping force is about 300-1500 tons.

In one embodiment, the composition of the present invention relates to automobile steel, in particular to a method for forming a coated steel plate or steel belt having good corrosion resistance. The steel plate or steel belt may be used for manufacture of automobile panels and other structural parts. After the hot stamping forming is completed, the steel plate or steel belt is cooled in the mold to about 500, 400, 300, 200° C. or less. The steel plate or steel belt is further cooled to room temperature after it is removed from the mold to complete the transformation. In another embodiment, the pressure holding time of the hot stamping forming is about 3-30 seconds, and the stamping force is about 300-1000 tons.

In some embodiments, an aluminum metal-particulate filled polysilazane coating composition is coil coated onto the surface of sheeted steel. The sheeted steel is pyrolyzed at temperatures of about 900° C. to about 1,100° C. under a pressure of about 450 tons to about 1,500 tons through a stamping process to form a shaped, sheeted steel part. The sheeted steel part comprises a corrosion-resistant and oxidation-resistant coating having a composite SiAlON ceramic on and within the surface of the shaped, sheeted steel part. The sheeted steel can be mild steel or stainless steel. In one embodiment, a particularly desirable steel composition is 22MnB5, which has a hot stamped tensile strength of about 1,500 MPa. The added boron in 22MnB5 provides some inherent oxidation-resistance to the body of the steel itself.

In another embodiment, an aluminum metal-particulate filled polysilazane coating composition is coil coated onto the surface of sheeted steel and pyrolyzed at a peak temperature of about 900° C. to about 1,100° C. In another embodiment, an aluminum metal-particulate filled polysilazane coating composition is hot stamped at a temperature of about 500° C. to about 850° C. under a pressure of about 100 tons to about 600 tons depending on the hot stamping temperature. In another embodiment, the coated sheeted steel hot stamped under a pressure of at least 10, 20, 30, 40, 50, 60, 70, 80, 90, 100, 150, 200, 250, 300, 350, 400, 450 Mpa or more pressure. In another embodiment, the coated sheeted steel hot stamped under a pressure of at most 1000, 900, 800, 700, 650, 600, 550, 500, 450, 400, 350, 300, 200, 100 Mpa or less pressure.

In one embodiment, the starting precursor polymer e.g., polysilazane, and compositions formed from it are kept in a dry atmosphere until a layer of ceramic has been formed on the object to be coated as the susceptibility of the preceramic materials to attack by water and other compounds having active hydrogens.

In some embodiments, an inert atmosphere is used. In another embodiment, an atmosphere may substantially comprise nitrogen, argon, or mixtures thereof. In another embodiment, an atmosphere may be an oxygen-containing atmosphere such as air. The additional oxygen added to the coating composition through either atmospheric moisture or oxygen itself would contribute to a SiAlON composition formed by pyrolyzing polysilazane in the presence of aluminum. In some embodiments, a reducing atmosphere, for example, nitrogen, argon, helium, carbon dioxide, combinations thereof, or the like, is used.

In some embodiments, the pre-ceramic compositions may contain additional additives, for example, nanoparticles, polysiloxanes, polysilsesquioxanes, and/or other thermosetting resins; such as, without limitation, epoxies, phenolics, resorcinolics, epoxy vinyl esters, and/or crosslink initiators. The crosslink initiator is a compound or composition that is capable of inducing the formation of crosslinks in the pre-ceramic resin. In some examples, crosslink initiators can be activated by electromagnetic radiation such as ultraviolet light, laser light, infrared radiation, and/or microwave radiation.

Advantageously, the composition and method of the present invention are useful in preparing a variety of coated objects. The major advantage of the invention is its provision of compositions capable of resisting hydrolytic attack and protecting normally oxidizable materials from oxidative deterioration, especially at elevated temperatures. This advantage is of particular importance in the protection of carbon/carbon composites, graphite, and metals used in aerospace and automotive applications, such as engine components, advanced nozzle system components, and high-temperature vehicle structures. Such coatings have particular utility in the manufacture of stamped steel parts that are used in the fabrication of vehicles, electronic devices, home furnishings, and appliances. Further, the compositions and method provide improvements in various chemo-mechanical attributes to demonstrate the novel utility present invention.

### EXAMPLES

Example 1. A coating composition is prepared by mixing 35.0 g of a vinyl-containing polysilazane and 25.5 g of aluminum metal particulate into 39.5 g of Aromatic 150 solvent. The coating is spray applied to a 22MnB5 steel panel and cured at 200° C. for a period of 20 minutes. The resulting dry film thickness is measured at 0.35-0.50 mils. Prior to pyrolysis, the cured panel is subjected to direct/reverse impact testing of up to 120 inch-pounds impact force. The coating is highly adherent except for slight pigment spalling in the impact zone. The panel is then heated to 958° C. for 7 minutes to effect austenitic conversion and concurrent conversion of the cured coating to a diffusion-bonded ceramic on and within the panel's surface. After exposure of the coating to 958° C. temperature for 7 minutes, the panel is then quickly quenched on a 200 lb. steel substrate to effect formation of the martensitic structure. Upon examination, it is determined that the coating is fully adherent, continuous, and presented a uniform appearance on the surface of the steel. No evidence of oxidation, surface degradation, or rust formation is observed. Full adherence of the coating is observed when subjected to direct/reverse impact testing of up to 120 inch-pounds.

Example 2. A coating composition is prepared by mixing 35.0 g of a vinyl-containing polysilazane and 16.0 g of an aluminum metal particulate in 49.0 g of Aromatic 150 solvent. The coating is spray coated onto a 22MnB5 steel panel and cured at 200° C. for a period of 20 minutes. The dry film thickness of the cured coating is 0.25-0.40 mils. The cured panel is subjected to direct/reverse impact testing up to 120 inch-pounds. The coating is completely adherent after the test. The panel is then heated to 958° C. for 7 minutes effect austenitic conversion and concurrent conversion of the cured coating to a diffusion-bonded ceramic on and within the panel's surface. Upon removal the from the furnace the panel is quickly quenched on a 200 lb. steel substrate to cause the formation of a martensitic structure within the steel panel. Upon examination, it is determined that the coating is fully adherent, continuous, and presented a uniform appearance on the surface of the steel. No evidence of oxidation, surface degradation, or rust formation is observed. Full adherence of the coating is observed when subjected to direct/reverse impact testing of up to 120 inch-pounds.

Example 3. A coating composition is prepared by mixing 52.0 g of a vinyl-containing polysilazane, 25.0 g of an aluminum metal particulate, and 3.0 g of 1,8-Diazabicyclo[5.4.0]undec-7-ene cure catalyst in 20.0 g of Aromatic 150 solvent. The coating is applied to a 22MnB5 steel panel using a pinch roller and then cured at 375° C. for 1 minute. The dry film thickness of the coating is 0.40-0.80 mils. The cured coating is subjected to direct/reverse impact testing of up to 160 inch-pounds force, and T-Bend testing to OT. The coating is completely adherent to the steel panel. The panel is then heated to 958° C. for 7 minutes to effect austenitic conversion and concurrent conversion of the cured coating to a diffusion-bonded ceramic on and within the panel's surface. The panel is removed from the furnace, quickly cooled to cause the formation of a martensitic structure within the steel, and then hot-stamped at production temperatures and pressures. The coating is fully adherent, continuous, and presented a uniform appearance on the surface of the panel. No evidence of oxidation, surface degradation, or rust formation is observed.

While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. A polymer-derived composition for providing a ceramic-based precursor coating on a metal surface, comprising:
one or more preceramic polymers admixed with one or more metal particulates,
wherein the composition is integrally disposed on and within the metal surface of a metal part through pressure-assisted pyrolysis of a metal particulate-filled preceramic polymer under appropriate conditions, thereby providing a corrosion-resistant and oxidation-resistant metal surface.

2. The composition of claim 1, wherein the preceramic polymer comprises silicon.

3. The composition of claim 1, wherein the preceramic polymer is selected from the group consisting of polysilanes, polycarbosilanes, polysiloxanes, and polysilazanes.

4. The composition of claim 1, wherein the preceramic polymer is a polysilazane.

5. The composition of claim 1, wherein the metal particulate is selected from the group consisting of aluminum and silicon.

6. The composition of claim 1, wherein the metal particulate comprises a ratio of silicon (Si) to aluminum (Al) atoms between 0.25:1.75 and 1.75:0.25.

7. The composition of claim 1, wherein the metal particulate comprises a ratio of silicon (Si) to aluminum (Al) atoms between 0.50:1.50 and 1.50:0.50.

8. The composition of claim 1, comprises a SiAlON-containing ceramic material.

9. The composition of claim 1, comprises polysilazane and aluminum metal particulate, wherein the polysilazane and aluminum metal particulate are used in sequential coil coating and hot stamping process.

10. The composition of claim 9, wherein the polysilazane and aluminum metal particulate react upon exposure to heat and pressure while preparing ceramic compositions.

11. The composition of claim 10, wherein the ceramic compositions react with the metal surface through a diffusion process to provide a composite coating.

12. The composition of claim 11, wherein the composite coating includes aluminum oxides, ceramic inclusions, and ferrous alloys on the metal surface, thereby inhibiting any corrosion or oxidation of the hot stamped part of the metal surface.

13. The composition of claim 1, wherein the precursor coating is coated onto the metal surface and then converted to a highly corrosion-resistant and oxidation-resistant coating, thereby making the precursor coating to be stable at high temperatures experienced during heat forming techniques.

14. The composition of claim 13, wherein the precursor coating to the composition onto the metal surface before pyrolysis comprises about 34 wt. % to about 94 wt. % polysilazane as a dry film coating.

15. The composition of claim 13, wherein the precursor coating to the composition onto the metal surface before pyrolysis comprises about 79 wt. % to about 88 wt. % polysilazane as a dry film coating.

16. The composition of claim 13, wherein the precursor coating to the composition onto the metal surface before pyrolysis comprises about 6 wt. % to about 66 wt. % aluminum metal as a dry film coating.

17. The composition of claim 13, wherein the precursor coating to the composition onto the metal surface before pyrolysis comprises about 12 wt. % to about 31 wt. % aluminum metal as a dry film coating.

18. The composition of claim 1, wherein the metal part is a ferrous metal part that is selected from the group consisting of iron, steel, and stainless steel.

19. The composition of claim 1, wherein the metal part is in the form of a continuous metal sheet.

20. A method of performing hot stamping for sheet material, comprising:
applying a precursor coating composition onto a surface of the steel material, wherein the precursor coating composition comprises one or more preceramic polymers admixed with one or more metal particulates,
wherein the composition is integrally disposed on and within a metal surface of a metal part through pressure-assisted pyrolysis of a metal particulate-filled preceramic polymer under appropriate conditions, thereby providing a corrosion-resistant and oxidation-resistant metal surface,
drying the precursor coating composition on the surface of the steel material;
hot stamping the coated steel material at a pre-defined temperature under a time and pressure conditions sufficient to pyrolyze precursor coating composition to form a protective coating on the surface of the steel, and
cooling the coated steel material.

21. The method of claim 20, wherein the pressure-assisted pyrolysis comprising:
applying a precursor coating composition comprising one or more preceramic polymers admixed with one or more metal particulates to the metal surface of a metal part through a spray or dip coating application;
curing the sprayed or dip-coated coating to a solid precursor-coating, and
pyrolyzing the solid precursor-coating on the metal part at a pre-defined temperature under an induced pressure.

22. The method of claim 21, wherein the precursor coating composition reacts to form a ceramic coating comprising silicon, aluminum, oxygen, and nitrogen (a SiAlON).

23. The method of claim 20, wherein the surface of the steel material is shaped through the hot stamping, comprising:
applying a precursor coil coating to the surface of the steel material through a coil coating process;
flashing a solvent from the surface of the steel material;
curing the coated surface of the steel material with precursor coil coating to a solid precursor-coating;
heating the surface of the steel material comprising the cured precursor coil coating through the application of heat, and
shaping the coated surface of the steel material at a temperature under an induced pressure through the hot stamping.

24. The method of claim 23, wherein the precursor coil coating comprises a polysilazane, aluminum metal, amine curing agent, and a solvent to the surface of the steel material.
